(19) United States
(12) Patent Application Publication
(10) Pub. No.: US 2013/0034363 A1
(43) Pub. Date: Feb. 7, 2013

(54) IMAGE HEATING APPARATUS

(71) Applicant: Nobuaki Hara, Abiko-shi (JP)

(72) Inventor: Nobuaki Hara, Abiko-shi (JP)

(73) Assignee: CANON KABUSHIKI KAISHA, Tokyo (JP)

(21) Appl. No.: 13/564,157

(22) Filed: Aug. 1, 2012

(30) Foreign Application Priority Data
Aug. 4, 2011 (JP) 2011-170802

(51) Int. Cl. G03G 15/20

(52) U.S. Cl. 399/69

(57) ABSTRACT

An image heating apparatus includes: a coil for generating magnetic flux; a heat generating member; a nip forming member; a power source; a temperature sensor; a controller for controlling the power source based on a detection result of the temperature sensor; an executing portion for executing an operation in a higher speed fixing mode using a thinner recording material and an operation in a lower speed fixing mode using a thicker recording material; and a prohibiting portion for prohibiting the electric power, supplied from the power source to the coil by the controller, from exceeding a limiter value. The limiter value in the lower speed fixing mode is executed is set so as to be higher than that in the higher speed fixing mode.

### FIELD OF THE INVENTION AND RELATED ART

The present invention relates to an image heating apparatus to be mounted in an image forming apparatus, such as a copying machine, a printer or a facsimile machine, for forming an image on a recording material. Particularly, the present invention relates to an image heating apparatus for heating the image by an image heating member of an induction heating type.

An image forming apparatus in which after a toner image is transferred onto a recording material fed from a feeding portion to an image forming portion, the recording material on which the toner image is transferred is nip-conveyed through a heating nip of a heat generating member (fixing roller or fixing belt) of a fixing device to fix an image on the recording material has been widely known. Also an image heating apparatus using an induction heating device as a heating source of the heat generating member has been put into practical use (Japanese Laid-Open Patent Application (JP-A) 2001-194940 and JP-A 2006-120533).

In the image heating apparatus using the induction heating device, when sheets of the recording material with a length smaller than a length of the heat generating member with respect to a rotation axis direction of the heat generating member are continuously passed through the image heating apparatus, a phenomenon that a temperature in non-sheet-passing regions located at end portions of the heat generating member is increased is caused to occur. This phenomenon is hereinafter referred to as non-sheet-passing portion temperature rise.

In JP-A 2001-194940, a plurality of magnetic cones are provided with respect to the rotation axis direction of the heat generating member (fixing belt) and with respect to the magnetic cones at both end portions, an opposing gap from the heat generating member is enlarged, so that the non-sheet-passing portion temperature rise is avoided.

In JP-A 2006-120533, a size of a magnetic flux shielding plate for covering an end portion of the heat generating member (fixing roller) is switched to keep a heating range at an outside position of the recording material at a certain width even when a size of the recording material is changed, so that the non-sheet-passing portion temperature rise is avoided. Further, a temperature sensor is provided at the end portion of the heat generating member to actually measure the non-sheet-passing portion temperature rise and then the number of sheets per unit time of the recording material fed by the feeding portion is controlled.

### SUMMARY OF THE INVENTION

A principal object of the present invention is to provide an image heating apparatus, in which a limiter of electric power supplied to a coil is provided for suppressing temperature rise at a non-sheet-passing temperature rise at a non-sheet-passing portion, capable of reinforcing an application performance to a recording material having a large thermal capacity in an operation in a mode in which an image on the recording material is heated at a low speed.

According to an aspect of the present invention, there is provided an image heating apparatus comprising: a coil for generating magnetic flux; a rotatable heat generating member for generating heat by the magnetic flux from the coil; a nip forming member for forming a nip, together with the heating member, in which an image on a recording material is to be heated; a power source for supplying electric power to the coil; a sensor for detecting a temperature of the heat generating member; a controller for controlling, on the basis of a detection result of the sensor, the power source so that the temperature of the heat generating member is a set image heating temperature; an executing portion for executing an operation in a first mode in which the heat generating member is rotated at a first speed when the recording material with a first thickness is conveyed into the nip and for executing an operation in a second mode in which the heat generating member is rotated at a second speed lower than the first speed when the recording material with a second thickness larger than the first thickness is conveyed into the nip; and a prohibiting portion for prohibiting the electric power, supplied from the power source to the coil by the controller, from exceeding a limiter value, wherein the limiter value when the operation in the second mode is executed is set so as to be higher than that when the operation in the first mode is executed.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is an illustration of a structure of an image forming apparatus.

FIG. 2 is an illustration of a structure of a principal portion of a fixing device (image heating apparatus).

FIG. 3 is a longitudinal sectional vie of the fixing device as seen from a secondary transfer portion side.

FIG. 4 is an illustration of a layer structure of a fixing belt.

Parts (a) and (b) of FIG. 5 are illustrations of movement of magnetic cores.

FIG. 6 is an illustration of a moving mechanism of the magnetic cores.

FIG. 7 is a perspective view of the fixing device.

Parts (a) to (c) of FIG. 8 are illustrations each showing an occurrence position of non-sheet-passing portion temperature rise.

FIG. 9 is a circuit diagram of an induction heating device.

FIG. 10 is a graph showing a temperature change of the fixing belt at a sheet passing portion and a non-sheet-passing portion when plain paper is fed at setting of the plain paper.

FIG. 11 is an illustration of a temperature distribution after continuous image formation of 500 sheets.

FIG. 12 is a graph showing a temperature change of the fixing belt at a sheet passing portion and a non-sheet-passing portion when thick paper is fed at setting of the thick paper.

FIG. 13 is an illustration of a temperature distribution after continuous image formation of 500 sheets.

FIG. 14 is a graph showing a temperature change of the fixing belt at a sheet passing portion and a non-sheet-passing portion in Comparative Embodiment when thick paper is fed at setting of the plain paper.

FIG. 15 is an illustration of a temperature distribution after continuous image formation of 500 sheets.

FIG. 16 is a graph showing a temperature change of the fixing belt at a sheet passing portion and a non-sheet-passing portion in Embodiment 1 when thick paper is fed at setting of the plain paper.

FIG. 17 is an illustration of a temperature distribution after continuous image formation of 500 sheets.

FIG. 18 is a flow chart of control in Embodiment 2.

### DESCRIPTION OF THE PREFERRED EMBODIMENTS

Hereinbelow, embodiments of the present invention will be described in detail with reference to the drawings. The present invention can be carried out also in other embodiments in which a part or all of constitutions of the respective embodiments are replaced by their alternative constitutions so long as in a constitution in which productivity is lowered with a larger fixing necessary heat quantity per sheet of a recording material, electric power for induction heating is limited.

Therefore, an image heating apparatus includes not only a fixing device for fixing a toner image on a recording material by heating the recording material on which the toner image is transferred but also an image adjusting apparatus for providing a desired surface property to an image by heating a toner image which is partly fixed or completely fixed. The image heating apparatus may also include a glossiness imparting apparatus for improving glossiness of an image by re-heating the image fixed on the recording material. A heat generating member may be either of a belt member or a roller member.

A constitution for variably setting a heating region is not limited to a constitution for moving magnetic cones in a contact and separation direction relative to an exciting coil but may also be the constitution as described in JP-A 2006-120533 in which the heating region is set by moving the magnetic flux shielding member.

An image forming apparatus can mount the image heating apparatus of the present invention irrespective of the types of monochromatic/full-color, sheet-feeding/recording material conveyance/intermediary transfer, a toner image forming method and a transfer method.

In the following embodiments, only a principal portion concerning formation/transfer/fixing of the toner image will be described but the present invention can be carried out in image forming apparatuses with various uses including printers, various printing machines, copying machines, facsimile machines, multi-function machines, and so on by adding necessary equipment, options, or casing structures.

### <Image Forming Apparatus>

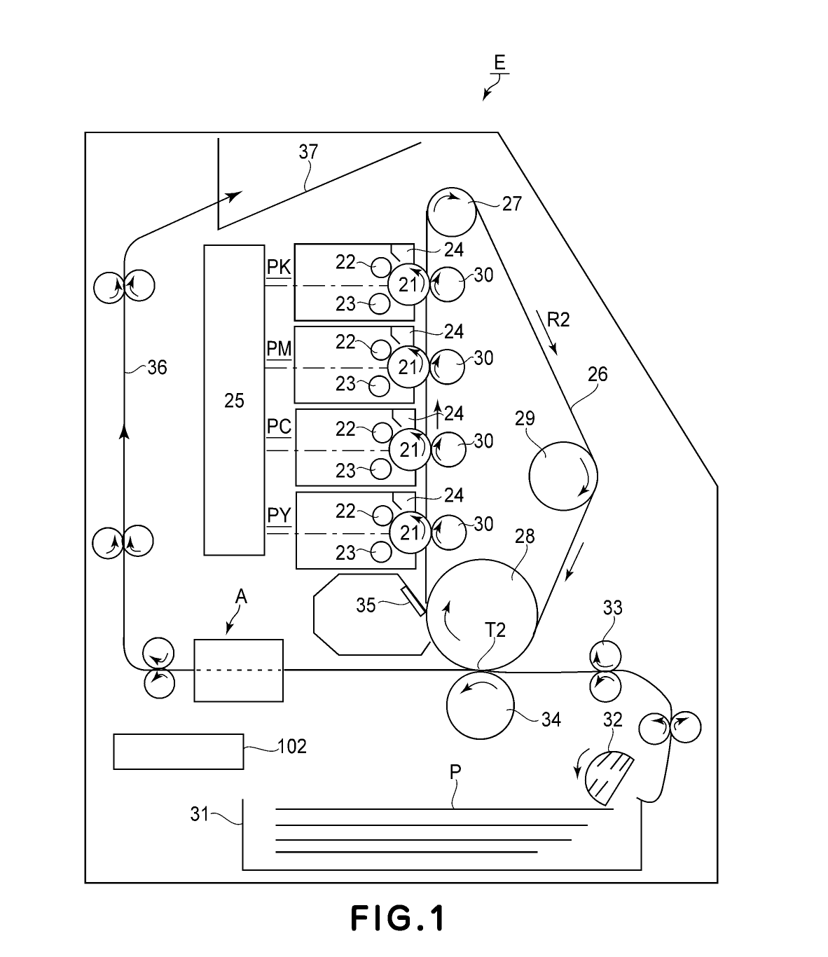

FIG. 1 is an illustration of structure of an image forming apparatus. As shown in FIG. 1, an intermediary transfer belt 26 which is an example of an image forming portion forms a toner image and transfers the toner image onto the recording material. An image forming apparatus E in this embodiment is a tandem-type full-color printer of an intermediary transfer type in which image forming portions PY, PC, PM and PK for yellow, cyan, magenta and black, respectively, are arranged along the intermediary transfer belt 26. On the intermediary transfer belt 26, the toner image is formed and transferred onto the recording material.

In the image forming portion PY, a yellow toner image is formed on a photosensitive drum 21(Y) and then is transferred onto the intermediary transfer belt 26. In the image forming portion PC, a cyan toner image is formed on a photosensitive drum 21(C) and is transferred onto the intermediary transfer belt 26. In the image forming portions PM and PK, a magenta toner image and a black toner image are formed on photosensitive drums 21(M) and 21(K), respectively, and are transferred onto the intermediary transfer belt 26.

The intermediary transfer belt 26 is constituted by an endless resin belt and is stretched around a driving roller 27, a secondary transfer opposite roller 28 and a tension roller 26, and is driven by the driving roller 26.

A recording material P is pulled out from a recording material cassette 31, which is an example of a feeding portion, one by one by a sheet feeding roller 32 and is in stand-by between registration rollers 33.

The recording material P is sent by the registration rollers 33 to a secondary transfer portion T2 where the toner images are transferred from the intermediary transfer belt 26 onto the recording material P. The recording material P on which the four color toner images are transferred is conveyed into a fixing device A is, after being heated and pressed by the fixing device A to fix the toner images thereon, discharged onto an external tray 37 via a discharge conveying path 36. Incidentally, during image formation of only a monochromatic (single) color (monochromatic (single) color mode), with respect to only an intended color, the toner image is formed and then carried on the intermediary transfer belt 26, and thereafter is transferred onto the recording material.

The image forming portions PY, PC, PM and PK have the substantially same constitution except that the colors of toners of yellow, cyan, magenta and black used in developing devices 23(Y), 23(C), 23(M) and 23(K) are different from each other. In the following description, the image forming portion PY will be described and other image forming portions PC, PM and PK will be omitted from redundant description.

The image forming portion PY includes the photosensitive drum 21 around which a charging roller 22, an exposure device 25, the developing device 23, a transfer roller 30, and a drum cleaning device 24 are disposed.

The charging roller 22 electrically charges the surface of the photosensitive drum 21 to a uniform potential. The exposure device 25 writes (forms) an electrostatic image for an image on the photosensitive drum 21 by scanning with a laser beam. The developing device 23 develops the electrostatic image to form the toner image on the photosensitive drum 21. The transfer roller 30 is supplied with a DC voltage, so that the toner image on the photosensitive drum 21 is transferred onto the intermediary transfer belt 26.

### <Fixing Device>

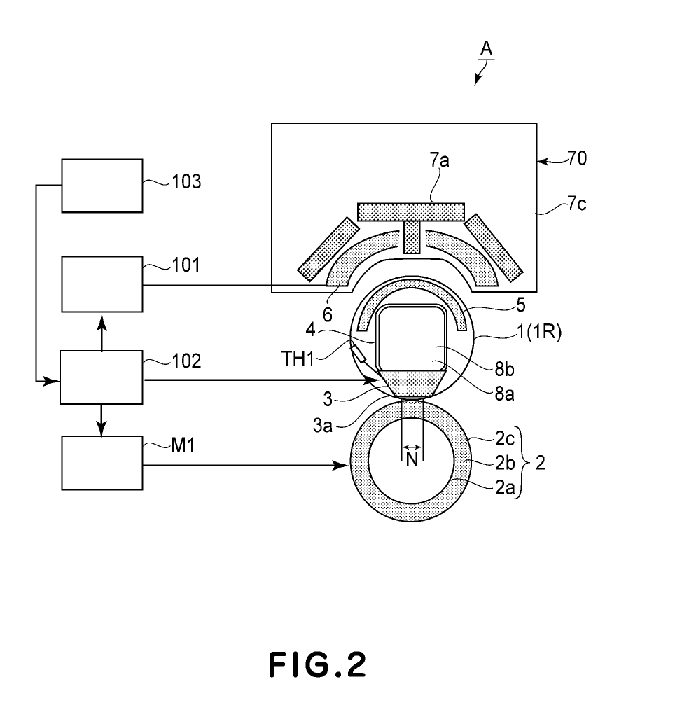

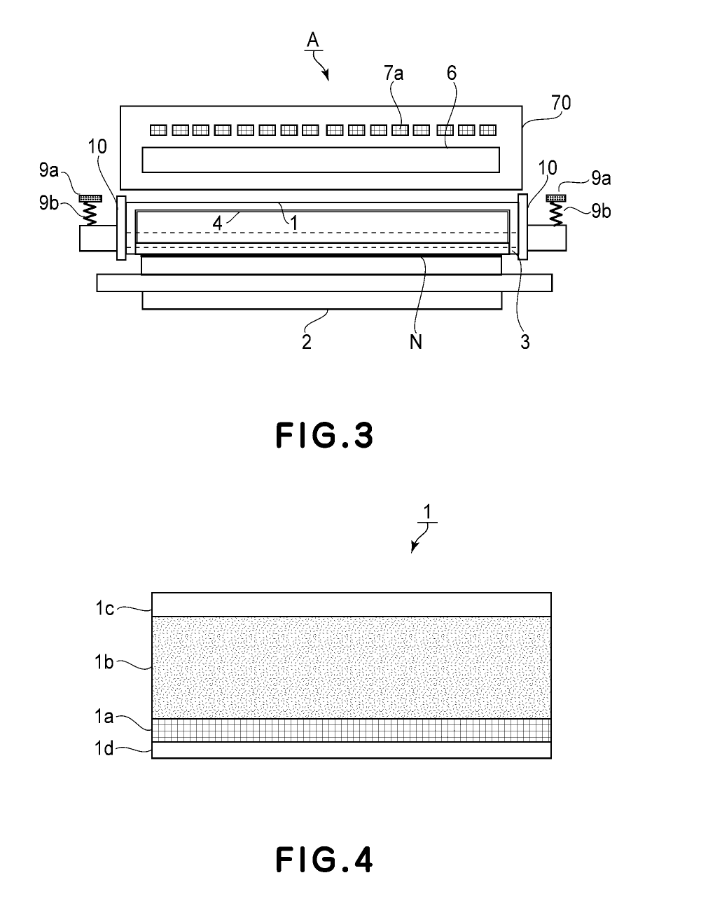

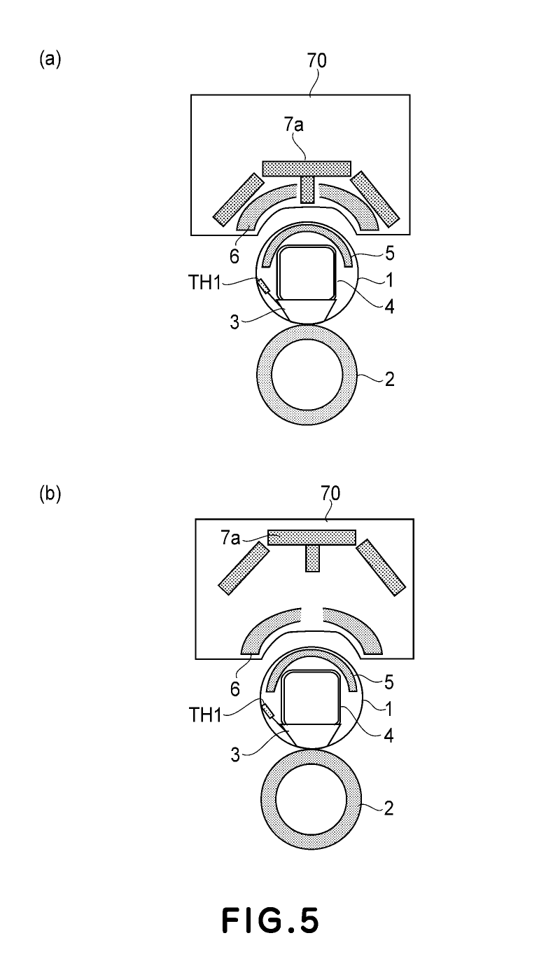

FIG. 2 is an illustration of a structure of a principal portion of the fixing device. FIG. 3 is a longitudinal sectional view of the fixing device as seen from the secondary transfer portion side. FIG. 4 is an illustration of a layer structure of a fixing belt 1. In the following description, with respect to the fixing device or a fixing roller, a widthwise direction is a direction parallel to a recording material conveyance direction. Further, with respect to the fixing device, a front surface refers to a surface as seen from a recording material entrance side, and a rear surface is a surface, as seen from a recording material exit side, opposite from the front surface. The left (side) and the right (side) of the fixing device refer to left (side) and right (side) as seen from the front surface side. An upstream side and a downstream side refer to an upstream side and a downstream side with respect to a recording material conveyance direction.

As shown in FIG. 2, the pressing roller 2 is prepared by providing an almost 5 mm-thick elastic layer 2b of a silicone rubber on a core metal 2a of iron alloy which is 20 mm in diameter at a central portion and is 19 mm in diameter at each of end portions. On a surface of the elastic layer 2b, a parting layer 2c of fluorine-containing resin (such as PFA or PTFE) is provided in a thickness of 30 μm. The pressing roller 2 has a hardness (Asker-C hardness) of 70 degrees at the central portion. The reason why the core metal 2a has a tapered shape is that even when a pressure-applying member 3 is bent under pressure application, pressure in a fixing nip N between the fixing belt 1 and the pressing roller 2 can be uniformly ensured with respect to a rotation axis direction of the fixing belt 1. The fixing belt 1 is 30 mm in inner diameter.

The core metal 2a is tapered, so that the thickness of the elastic layer 2b is different between the central portion and each of the end portions. For this reason, a length of the fixing nip N between the fixing belt 1 and the pressing roller 2 is, when the fixing nip pressure is 600 N, about 9 mm at each of the end portions and about 8.5 mm at the central portion. As a result, a conveying speed of the recording material P at each of the end portions is higher than that at the central portion, so that there is such an advantage that paper creases are not readily gaped.

The pressure-applying member 3 is held by a metal stay 4 at its inner surface and supports an inner surface of the fixing belt 1 by its outer surface. The pressure-applying member 3 applies an urging force (pressure) to the pressing roller 2 via the fixing belt 1, thus forming the fixing nip N between the fixing belt 1 and the pressing roller 2. The pressure-applying member 3 is formed of a heat-resistant resin material. In a side where the stay 4 opposes an exciting coil 6, a magnetic flux shielding core 5 as a magnetic flux shielding member for preventing temperature rise of the stay 4 caused due to induction heating is provided.

As shown in FIG. 3, the stay 4 is required to have rigidity in order to apply pressure to the press-contact portion between the fixing belt 1 and the pressing roller 2 and therefore is formed of metal. The stay 4 is close to the exciting coil 6 particularly at end portions and in order to shield a magnetic field generated by the exciting coil 6 so as to prevent heat generation of the stay 4, the magnetic flux shielding core 5 is disposed over the upper surface of the stay 4.

The fixing flanges 10 are left and right preventing members (regulating members) for preventing (regulating) rotation axis directional movement of and circumferential shape of the fixing belt 1 are provided. A stay urging spring 9b is compressedly provided between each end portion of the stay 4 provided by being inserted into the flanges 10 and a spring receiving portion 9a provided in a device chassis side, so that a pressing-down force is applied to the stay 4. As a result, the lower surface of the pressure applying member 3 and the upper surface of the pressing roller 2 are press-contacted to the fixing belt 1 therebetween, so that the fixing nip N for the image on the recording material is formed. A base layer of the rotating fixing belt 1 is formed of metal and therefore even in the rotation state, as a means for preventing deviation (shift) in a widthwise direction, provision of the fixing flanges only for simply receiving the end portions of the fixing belt 1 suffice. As a result, there is the advantage such that the constitution of the fixing device can be simplified.

As shown in FIG. 4, the fixing belt 1 includes a 40 μm-thick base layer (metal layer) 1a of nickel which is manufactured through electroforming.

As a material for the base layer 1a, in addition to nickel, an iron alloy, copper, silver or the like is appropriately selectable. Further, the base layer 1a may also be constituted so that a layer of the metal or metal alloy described above is laminated on a resin material base layer. The thickness of the base layer 1a may be adjusted depending on a frequency of a high-frequency current caused to flow through the exciting coil described later and depending on magnetic permeability and electrical conductivity of the base layer and may be set in a range from 5 μm to 200 μm.

On the other peripheral surface of the base layer 1a, an elastic layer 1b which is a heat-resistant silicone rubber layer is provided. The thickness of the elastic layer 1b may preferably be set within a range of 100-1000 μm. In this embodiment, in consideration of reduction in a warming-up time by decreasing thermal capacity of the fixing belt 1 and obtaining of a suitable fixed image when the color images are fixed, the thickness of the elastic layer 1b is 300 μm. The silicone rubber layer as the elastic layer 1b has a hardness (JIS-A) of 20 degrees and is 0.8 W/mK in thermal conductivity. On the other peripheral surface of the elastic layer 1b, a parting layer 1c of fluorine-containing resin (such as PFA or PTFE) is formed in a thickness of 30 μm. On the inner surface of the base layer 1a, in order to lower sliding friction between the fixing belt inner surface and a central thermistor (TH1 in FIG. 2), a lubricating layer 1d of fluorine-containing resin or polyimide is formed in a thickness of 10-50 μm. In this embodiment, a 20 μm-thick polyimide layer was provided as the lubricating layer 1d.

### <Induction Heating Device>

As shown in FIG. 2, the induction heating device 70 is a heating source for induction-heating the fixing belt 1. The induction heating device 70 is disposed opposed to the fixing belt 1 with a predetermined gap (spacing) in an upper peripheral surface side of the fixing belt 1.

The exciting coil 6 uses Litz wire as an electric wire and is prepared by winding Litz wire in an elongated ship's bottom-like shape so that the exciting coil 6 opposes a part of the peripheral surface of the fixing belt 1. The exciting coil 6 is 352 mm in inner diameter and 392 mm in outer diameter with respect to the longitudinal direction.

Magnetic cores 7a are provided so as to cover the exciting coil 6 so that the magnetic field generated by the exciting core 6 is not substantially leaked to a portion other than the metal layer (electroconductive layer) of the fixing belt 1. The magnetic cores 7a have the function of efficiently guiding AC magnetic flux generated from the exciting coil 6 to the fixing belt 1. The magnetic cores 7a are used for increasing an efficiency of a magnetic circuit of the AC magnetic flux and for shielding the magnetic flux so as to avoid induction heating of peripheral members caused by leakage of the magnetic flux to the peripheral members. As a material for the magnetic cores 7a, a material such as ferrite having high permeability and low residual magnetic flux density.

A mold member 7c supports the exciting coil 6 and the magnetic cores 7a by an electrically insulating resin material. The fixing belt 1 and the magnetic cores 7a are kept in an electrically insulating state by the mold member 7c having a thickness of 0.5 mm. A spacing between the fixing belt 1 and the exciting coil 6 is constant at 1.5 mm (i.e., a distance between the mold surface and the fixing belt surface is 1.0 mm).

In the rotation state of the fixing belt 1, to the exciting coil 6 of the induction heating device 70, a high-frequency current of 20-50 Hz is applied from a power source (supply) device (exciting circuit) 101, so that the metal layer (electroconductive layer) of the fixing belt 1 is induction-heated by the magnetic field generated by the exciting coil.

The central thermistor TH1 is a temperature sensor (temperature detecting element) and is provided at a widthwise central portion of the fixing belt 1 in contact to the fixing belt 1. The central thermistor TH1 is mounted to the pressure applying member 3 via an elastic supporting member and therefore even when positional fluctuation such as waving of a contact surface of the fixing belt 1 is generated, the central thermistor TH1 follows the positional fluctuation and is kept in a good contact state to the fixing belt 1. The central thermistor TH1 detects the temperature of the inner surface of the fixing belt 1 substantially at a center of a recording material conveying region, so that detected temperature information is fed back to the controller 102.

The controller 102 controls the electric power supplied from the power supply device 101 to the exciting coil 6 so that the detected temperature inputted from the central thermistor TH1 is kept at a predetermined target temperature (fixing temperature). The controller 102 interrupts energization to the exciting coil 6 in the case where the detected temperature of the fixing belt 1 is increased up to the predetermined temperature.

The controller 102 changes, on the basis of a detected value of the central thermistor TH1, the frequency of the high-frequency current so that the detected temperature of the fixing belt 1 is constant at 180° C. as the target temperature of the fixing belt 1, thus controlling the electric power inputted into the exciting coil 6 to adjust the temperature. The exciting coil 6 of the induction heating device 70 connected to the power supply device 101 is controlled by the controller 102, so that the fixing belt 1 is heated to the predetermined fixing temperature.

As described above, to the exciting coil 6, the high-frequency current of 20-50 kHz is applied, so that the metal layer 1a of the fixing belt 1 is induction-heated. Temperature adjustment is made by controlling the electric power inputted into the exciting coil 6 by changing, on the basis of the detected value of the central thermistor TH1, the frequency of the high-frequency current so that the fixing belt temperature is kept at 180° C. as the target temperature of the fixing belt 1.

The induction heating device 70 including the exciting coil 6 is not disposed inside the fixing belt 1 which becomes a high temperature but is disposed inside the fixing belt 1 and therefore the temperature of the exciting coil 6 is not readily increased to the high temperature. Further, also an electric resistance is not increased, so that even when the high-frequency current is carried, it becomes possible to alleviate loss caused by Joule heat generation. Further, by externally disposing the exciting coil 6, the fixing belt 1 is downsized (low thermal capacity), so that it can be said that the induction heating device 70 is excellent in an energy saving property.

With respect to the warming-up time of the fixing device A in this embodiment, a constitution in which the thermal capacity is very low is employed and therefore when, e.g., 1200 W is inputted into the exciting coil 6, the temperature of the fixing device A can reach 165° C. as the target temperature in about 15 sec. There is no need to perform a heating operation and therefore electric power consumption can be suppressed at a very low level.

The fixing belt is rotationally driven at a peripheral speed, substantially equal to a conveying speed of the recording material P conveyed from the secondary transfer portion T2 in FIG. 1 during the image formation, by rotational drive of the pressing roller 2 by a motor M2 controlled by the controller 102. In the fixing device A, a surface rotational speed of the fixing belt 1 is 300 mm/sec and it is possible to fix a full-color image on 80 sheets per minute in the case of A4-size long edge feeding and 58 sheets per minute in the case of A4-size short edge feeding.

The recording material P on which an unfixed toner image T is guided by a guide member 7 with its toner image carrying surface toward the fixing belt 1 to be introduced into the fixing nip N formed between the fixing belt 1 and the pressing roller 2 under pressure. The recording material P is, in the fixing nip N, intimately contacted to the outer peripheral surface of the fixing belt 1, thus being nip-conveyed together with the fixing belt 1 through the fixing nip N.

The unfixed toner image T is fixed on the surface of the recording material P by being pressed in the fixing nip N while being supplied with heat of the fixing belt 1. The surface of the recording material P passing through the fixing nip N is deformed at an exit portion of the fixing nip N, so that the recording material P is self-separated from the outer peripheral surface of the fixing belt 1 to be conveyed to the outside of the fixing device A.

### <Magnetic Core Moving Mechanism>

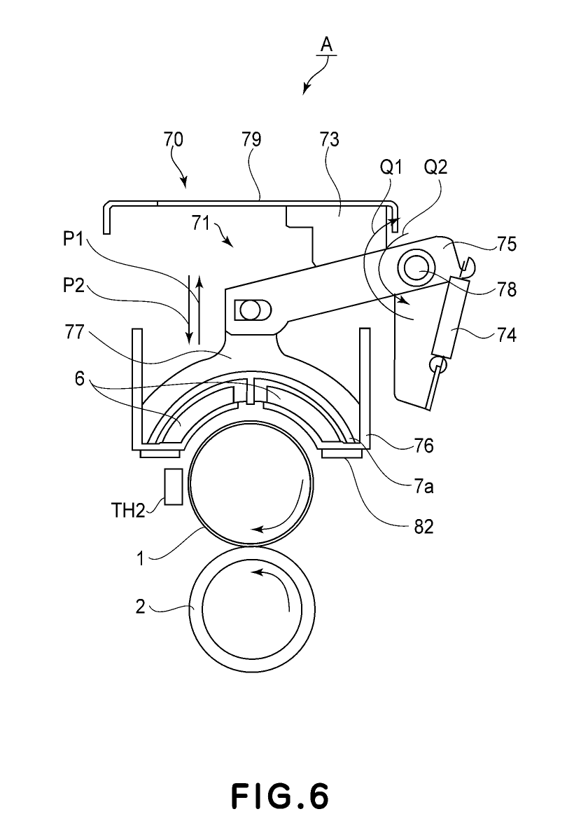

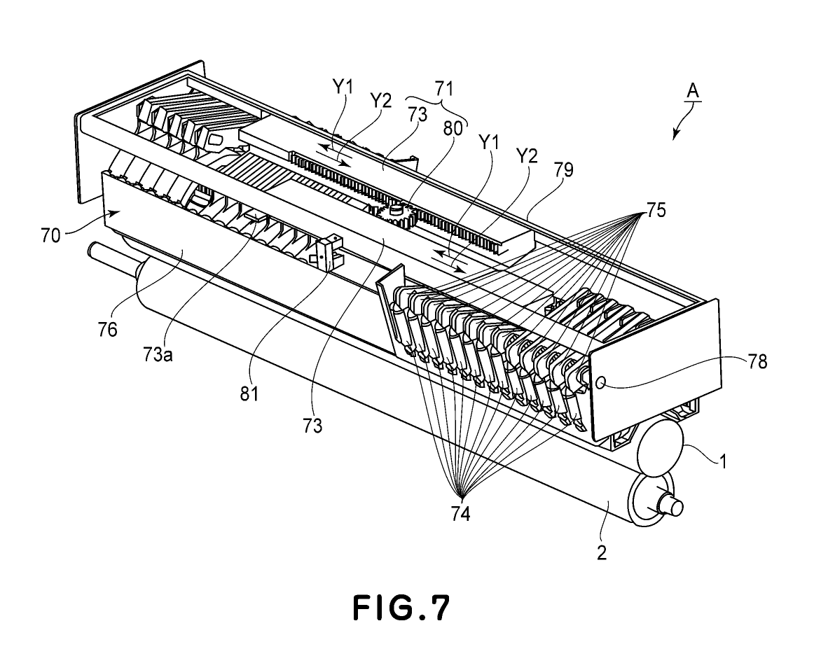

Parts (a) and (b) of FIG. 5 are illustrations of movement of magnetic cores. FIG. 6 is an illustrations of a moving mechanism of the magnetic cores. FIG. 7 is a perspective view of the fixing device.

As shown in FIG. 2, the fixing belt 1 which is an example of the heat generating member is rotated while being heated by the magnetic flux of the exciting coil 6 which is an example of a coil, thus heating the image formed on the recording material. The power source device 101 which is an example of an energization control means controls electric power supply to the exciting coil 6 so that the temperature of the fixing belt 1 becomes a preset image heating temperature. The power source device 101 controls the electric power supply to the exciting coil 6 so that the temperature of the fixing belt 1 is kept in a predetermined temperature range necessary to fix the toner image. The plurality of the magnetic cones 7a are arranged in the rotation axis direction of the fixing belt 1 to guide the magnetic flux generated by the exciting coil 6 to the fixing belt 1 in associated regions.

As shown in FIG. 3, the magnetic cones 7a are divided with respect to the rotation axis direction of the fixing belt 1 and are disposed so that a length of each magnetic cone with respect to the rotation axis direction is 10 mm and an interval between adjacent magnetic cones is 1.0 mm. At the sheet passing portion, by narrowing the gap between the exciting coil 6 and the magnetic cores 7a, a density of the magnetic flux passing through the fixing belt 1 is increased, so that an amount of heat generation of the fixing belt 1 is increased.

On the other hand, at the non-sheet-passing portion, by increasing the gap between the exciting coil 6 and the magnetic cores 7a, the density of the magnetic flux passing through the fixing belt 1 is decreased, so that an amount of heat generation of the fixing belt 1 is decreased.

As shown in (a) of FIG. 5, in the sheet passing region, the gap between the exciting coil 6 and the magnetic cones 7a is 0.5 mm. As shown in (b) of FIG. 5, in the non-sheet-passing region, the gap between the exciting coil 6 and the magnetic cones 7a is increased to 10 mm.

As shown in FIG. 6, a core moving mechanism 7a which is an example of an adjusting means adjusts a distribution of the magnetic flux directed from the exciting coil 6 toward the fixing belt 1 with respect to the rotation axis direction of the fixing belt 1. The core moving mechanism 71 sets a region of the image heating temperature by moving the magnetic cones 7a, in the number corresponding to the length of the recording material with respect to the rotation axis direction of the fixing belt 1, closer to the fixing belt 1 than other magnetic cones 7a. The core moving mechanism 7a is capable of adjusting, when the recording material with a length smaller than that of a passable maximum-sized recording material with respect to the rotation axis direction of the fixing belt 1 is passed through the fixing nip N, the magnetic flux distribution so that the magnetic flux density in a predetermined region including the sheet passing region is larger than that in a region outside the predetermined region as shown in FIG. 8.

The plurality of the magnetic cones 7a are movable in a contact and separation direction relative to the fixing belt 1. The plurality of the magnetic cones 7a are arranged in the rotation axis direction of the fixing belt 1 and guide the magnetic flux generated by the exciting coil 6 to the fixing belt 1 in the respective regions. The controller 102 sets the region of the image heating temperature by moving the magnetic cones 7a in the number corresponding to the length of the recording material with respect to the widthwise direction close to the fixing belt 1 than other magnetic cones 7a.

The magnetic cores 7a are accommodated in a housing 76 while being held by a magnetic core holder 77. The magnetic core holder 77 is movable in a direction in which the gap between the exciting coil 6 and the magnetic cores 7a is changed. A link member 75 is assembled rotatably about a rotation shaft 76 and is connected to the magnetic core holder 77 at an elongated hole portion provided at its end portion. When the link member 75 is rotated about the rotation shaft 78 in Q1 direction, the magnetic core holder 77 and the magnetic cores 7a are moved in P1 direction. When the link member 75 is rotated about the rotation shaft 78 in Q2 direction, the magnetic core holder 77 and the magnetic cores 7a are moved in P2 direction. The link member 75 is surged by an exciting coil spring 74 in a direction in which it is rotated in the Q1 direction, but is prevented from moving in the Q1 direction by a regulating (preventing) member 73.

In a state in which the link member 75 is pressed-in by the regulating member 73, the link member 75 is rotationally moved in the Q2 direction against the exciting coil spring 74. At this time, the magnetic core holder 77 is moved in the arrow P2 direction, so that the magnetic cores 7a approach the exciting coil 6.

When the pressing-in of the link member 75 by the regulating member 73 is released (eliminated), the link member 75 is rotationally moved in the Q1 direction by being urged by the exciting coil spring 74 and thus is abutted against a frame 79 to be stopped. As a result, the magnetic core holder 77 is moved in the arrow P1 direction, so that the magnetic cores 7a are moved away from the exciting coil 6.

As shown in FIG. 7, the regulating member 73 is connected to a central pinion gear 80 and is movable in widthwise directions (Y1 and Y2 directions) perpendicular to the recording material conveyance direction by rotational motion of the pinion gear 80. When the regulating member 73 is moved in the Y1 direction, the pressing-in by the regulating member 73 successively released from an end portion-side link member 75, so that the magnetic cores 7a are moved away from the exciting coil 6 successively from an end portion side toward a central portion side. In FIG. 7, with respect to four magnetic cores 7a from the end portion side, the pressing-in by the regulating member 73 is released, so that the gap between the exciting coil 6 and the magnetic cores 7a is increased.

### <Non-Sheet-Passing Portion Temperature Rise>

Parts (a) to (c) of FIG. 8 are illustrations each showing an occurrence position of the non-sheet-passing portion temperature rise. In order to enable high-speed temperature rise during actuation of the fixing device, fixing devices such as a fixing device in which a fixing roller is formed in a small thickness and is downsized, a fixing device in which a fixing belt is internally heated by a heater, and a fixing device in which a thin metal fixing belt is induction-heated have been conventionally proposed.

Also from the viewpoints of material cost and energy efficiency, in the image forming apparatus E, it is a desirably tendency that the thermal capacity is decreased by using a thin heat generating member and the fixing belt is heated by the induction heating device with a good heating efficiency.

However, in the case where the thin heat generating member is used, a cross-sectional area of a cross section perpendicular to the rotation axis direction is very small and therefore a heat transfer efficiency with respect to the rotation axis direction is not good. This tendency is conspicuous with a smaller thickness of the heat generating member, and is further low for a resin material with a low thermal conductivity.

This is also clear from the Fourier's law such that a heat quantity Q transmitted per unit time is, when the thermal conductivity is λ, a temperature difference between two point is θ1−θ2 and a length between the two points is L, represented by the following formula:

Q=λ×f(θ1−θ2)/L.

In a state in which a heat transfer efficiency of the heat generating member with respect to the rotation axis direction is not good, when the small-sized recording material is subjected to the continuous sheet passing, the temperature of the heat generating member in the non-sheet-passing region is increased more than in the sheet passing region, so that a problem of a so-called non-sheet-passing portion temperature rise such that temperature non-uniformity of the heat generating member with respect to the rotation axis direction occurs is caused to be generated.

When this non-sheet-passing portion temperature rise occurs, when a large-sized recording material is heated immediately after sheets of a small-sized recording material are continuously heated, heating non-uniformity occurs on the recording material, thus causing paper creases and improper fixing. In the case where remarkable non-sheet-passing portion temperature rise occurs, a lifetime of peripheral members of a resin material is lowered in some cases. The degree of the non-sheet-passing portion temperature rise is enlarged with a larger thermal capacity of the recording material to be conveyed and with a larger print number per unit time. For this reason, in a copying machine with the high throughput, a fixing device using the thin rotatable member and the induction heating device with a good heating efficiency in combination could not be employed. In the copying machine with high productivity, in many cases, the non-sheet-passing portion transfer was avoided by dividing a halogen lamp heater or a heat generating resistor into a plurality of portions and then by heating a region depending on the recording material size.

As in JP-A 2001-194940 described above, also in the fixing device using the thin heat generating member and the induction heating device with the good heating efficiency in combination, an example in which the heating region of the heat generating member with respect to the rotation axis direction is settable depending on the recording material size is proposed. However, when the induction heating device is provided in the plurality of portions, or is divided, the control circuit is complicated and is increase in cost correspondingly. In the case of the thin heat generating member, there is also a problem such that a temperature distribution is discontinuous in the neighborhood of boundaries of divided heating regions and thus the heat generating member cannot satisfy a necessary temperature uniformity.

Therefore, in the fixing device A, between the fixing belt 1 and the exciting coil 6, the magnetic cores 7a capable of setting, a region, every 10 mm in width, of the magnetic flux guided from the exciting coil 6 to the fixing belt 1 are disposed. In order to meet various sizes of the recording material, the divided magnetic cores 7a extend in a convey width direction perpendicular to the recording material conveyance direction and is made movable by the core moving mechanism 71, so that a movement distance is changed depending on the recording material size. By moving the magnetic cores 7a in a number corresponding to a conveying widthwise size of the recording material, a degree of the magnetic flux sent from the induction heating device 70 in a region other than a region necessary to be heated is decreased, so that the heat generation of the fixing belt 1 itself is suppressed. As a result, control of the heating region is effected, so that it becomes possible to precisely control the temperature distribution of the fixing belt 1 to be increased in temperature.

As shown in FIG. 6, the controller 102 controls the core moving mechanism 71 to release the pressing-in by the regulating member 73 with respect to a predetermined number of the magnetic cores 7a in the magnetic core holder 77 determined depending on a conveyance widthwise direction of the recording material. As a result, the gap between the exciting coil 6 and the magnetic cores 7a located outside the recording material is increased, so that the non-sheet-passing portion transfer is prevented. In order to meet various recording material sizes such as postcard size, A5 size, B4 size, A3 size and A3 plus size, the position of the regulating member 73d is changed depending on the recording material size, so that a heating region depending on each recording material size is set and thus the non-sheet-passing portion transfer is suppressed.

However, in the fixing device A using the induction heating device 70, there arises the following problem. As shown in FIG. 8, in the case where recording materials 1, 2 and 3 of different sizes are passed through the fixing device A, longitudinal temperature distributions of the fixing belt 1 are as shown in (a), (b) and (c) of FIG. 8, respectively. In each of the cases of the recording materials 1, 2 and 3, positions indicated by “” are maximum temperature portions but these maximum temperature portions are somewhat outside a conveyance with direction size of the associated one of the recording materials 1, 2 and 3. That is, depending on the recording material conveyance width direction size, the position of the maximum temperature portion with respect to the rotation axis direction of the fixing belt 1 varies.

Therefore, in the image forming apparatus E in which the recording materials of various sizes can be passed through the fixing device A, it is difficult to always detect the temperature of the fixing belt 1 at the maximum temperature portion. It would be not impossible that the temperature of the fixing belt 1 at the maximum temperature portion is detected by providing a plurality of temperature detecting elements in the number corresponding to the number of sizes of the recording material but this is not practical from the viewpoints of a cost and an arrangement space.

In the thus-constituted fixing device A, in the case where the temperature of the fixing belt 1 at the maximum temperature portion becomes an unexpected temperature for some reason, there is a possibility that the fixing belt 1 is exposed to a temperature exceeding a design temperature and thus a durable lifetime of the fixing belt 1 is shortened.

For example, when image formation is started at an interval (rate) of 75 sheets/min on the assumption that the recording material of plain paper of 80 g/m² in basis weight (weight per unit area) is used, in some cases, the recording material of thick paper of 160 g/m² in weight per unit area is fed from the feeding portion. At this time, the induction heating device 70 heats the entire heating region more than the case of the plain paper in order to supplement heat quantity taken by the thick paper, so that the degree of the non-sheet-passing portion temperature rise is higher than that in the case of the plain paper.

Therefore, in the following embodiments, an output limiter of the induction heating device 70 is set at a level where the non-sheet-passing portion temperature does not exceed the design temperature, so that the temperature of the fixing belt 1 at the maximum temperature portion is prevented from being increased unexpectedly to exceed the design temperature.

### Embodiment 1

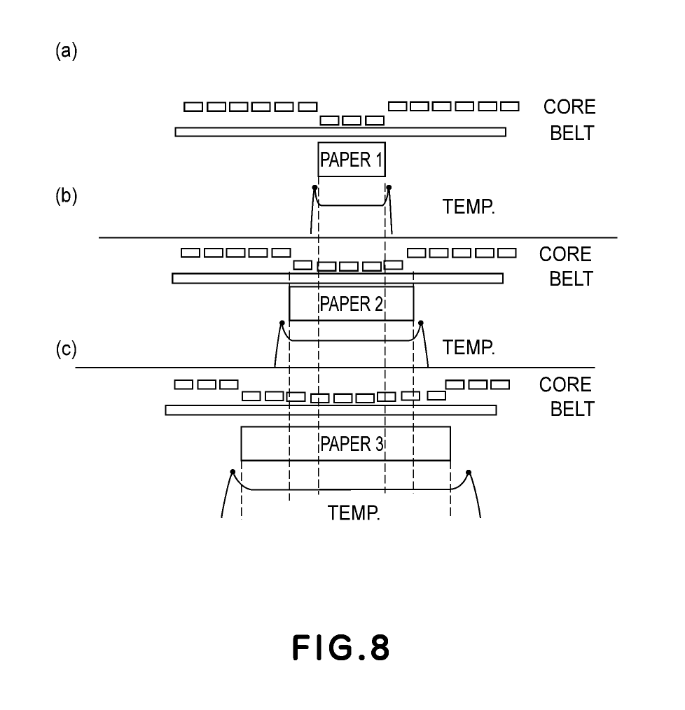

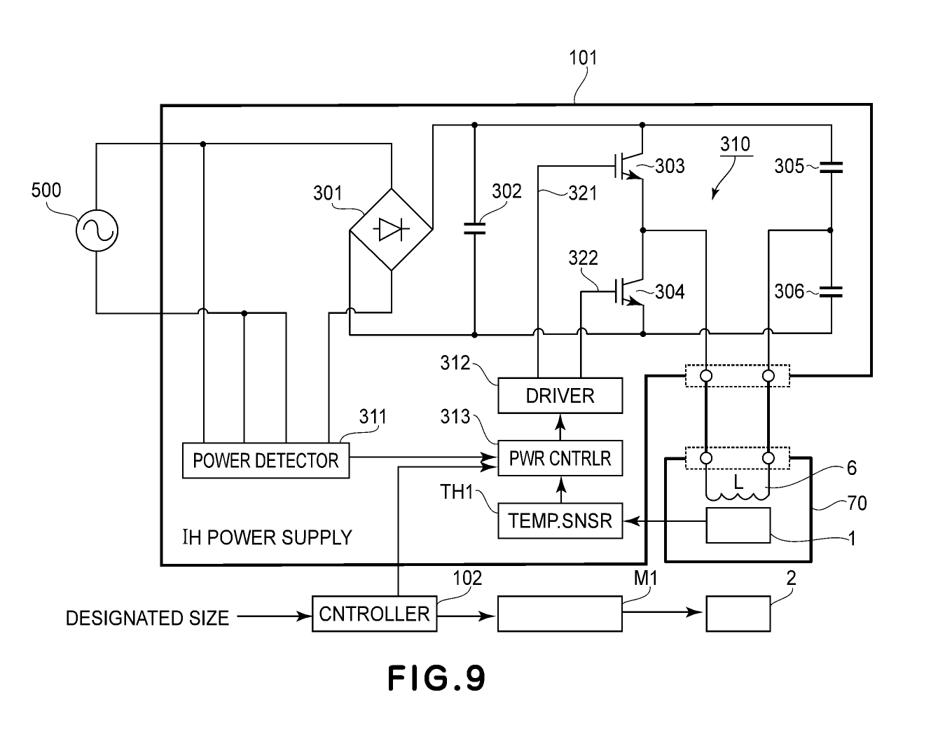

FIG. 9 is a circuit diagram of the induction heating device. As shown in FIG. 2, into the operating portion 102 which is an example of an inputting portion, information on the basis weight of the recording material is inputted. The controller 102 which is an example of a setting means sets a value of maximum electric power, supplied to the exciting coil 6 when the recording material with a first basis weight is passed through the fixing device, so as to be smaller than that supplied to the exciting coil 6 when the recording material with a second basis weight smaller than the first basis weight is passed through the fixing device.

The reason for this will be described. In order to ensure a fixing property for the recording material such as the thick paper with a large thermal capacity, setting of a low-speed mode in which a conveying speed is lowered is effective. In order to widen a range of the thick paper to which an operation in the low-speed mode is applicable, an increase in electric power supplied to the coil is effective. That is, a limiter of the electric power usable in the operation in the low-speed mode may desirably be as large as possible.

Incidentally, in this embodiment, the electric power limiter is provided in order to suppress that the fixing belt temperature at the non-sheet-passing portion reaches a limit temperature. According to study by the present inventor, it was understood that when the conveyance speed is lowered, an amount of heat dissipation from the fixing belt 1 to the pressing roller 2 at the non-sheet-passing portion becomes large. That is, even when the supplied electric power is the same, at a lowered conveyance speed, the fixing belt temperature is not readily increased at the non-sheet-passing portion. That is, in the operation in the low-speed mode, an electric power limiter value can be set at a high level. Therefore, in a constitution in which the electric power limiter is provided in order to suppress that the fixing belt temperature at the non-sheet-passing portion reaches the limit temperature, by increasing the supplied electric power in the operation in the low-speed mode, an applicable thick paper range can be widened.

As shown in FIG. 9, the induction heating device 70 controls the supplied electric power so that the temperature of the fixing belt 1 can be kept at a predetermined value. The power source device 101 which is an example of a power source portion induction-heats the fixing belt 1 by the induction heating device 70 with the electric power not more than a set electric power value. An exciting circuit 310 supplies a high-frequency AC current to the exciting coil 6 of the induction heating device 70. The exciting coil 6 is connected at an intermediate portion between a connecting point between switch elements 303 and 304 in the exciting circuit 310 and a connecting point between capacitors 305 and 306 in the exciting circuit 310. The exciting coil 6 generates the magnetic flux to induction-heat the fixing belt 1.

As shown in FIG. 2, the controller 102 sets, in the recording material cassette 31 and an electric power controller 313, a combination of a maximum electric power value (W) and a throughput or productivity (ppm) which is an example of a quantity per unit time depending on the type of the recording material designated through the operating portion 103 for the image formation. In the present invention, the combination of the throughput (productivity) and the electric power value is a combination for keeping the temperature, at the non-sheet-passing portion which is not contacted to the recording material located inside of the heating region with respect to the conveyance width direction, at a level of not more than a predetermined design temperature higher than a predetermined temperature (state).

The power source device 101 constitutes a rectifying smoothing circuit by a diode bridge 301 and a filter capacitor 302 to generate a DC voltage. The electric power controller 313 alternately actuates the switch elements 303 and 304 via a driver 312 to apply an AC voltage to the exciting coil 6. The capacitors 305 and 306 are a resonant capacitor for forming a resonant circuit together with the exciting coil 6. The driver 312 independently drives the two switch elements 303 and 304 in synchronism with each other.

A central thermistor TH1 functioning as a temperature sensor is provided in a contact state at an inner surface of the fixing belt 1 which is an electroconductive heat generating member, and detects the temperature of the fixing belt 1. An electric power detecting portion 311 detects an input electric power of the power source device.

The electric power controller 313 controls, on the basis of a command from the controller 102, the power source device 101 to actuate/stop the induction heating device 70. The electric power controller 313 determines a condition of the electric power, outputted from the driver 312, so that a detection temperature of the central thermistor TH1 converges to a control temperature designated by the controller 102. The electric power controller 313 determines the condition of the electric power, outputted from the driver 312, so that a detection output of the electric power detecting portion 311 does not exceed a set value of the maximum electric power designated by the controller 102. The driver 312 drives the two switch elements 303 and 304 in accordance with the electric power condition determined by the electric power controller 313.

As shown in Table 1 below, in the controller 102, every range of the basis weight of the recording material, a set value of each of the control temperature, the throughput (productivity) which is the number of sheets per unit time of the recording material to be heated, and the maximum electric power, the combination of the throughput (productivity) and the electric power value (maximum electric power setting) is set so that the temperature at the non-sheet-passing portion in the continuous image formation converges to the design temperature even when the weight per unit area of the recording material designated for the image formation is changed. Particularly, in Embodiment 1, the productivity is set depending on the designated recording materials so that the non-sheet-passing portion temperature is kept at the design temperature. However, the maximum electric power is set at a roughly constant value irrespective of the designated recording materials.

TABLE 1

| BW*¹ | CT*² | P*³ | MEP*⁴ |
|---|---|---|---|
| (g/m²⁾ | (° C.) | (sheets/min) | (W) |
| 41-60 | 150 | 75 | 900 |
| 61-100 | 160 | 75 | 1000 |
| 101-160 | 160 | 60 | 1000 |
| 161-200 | 170 | 50 | 1000 |

*¹“BW” represents the basis weight.
*²“CT” represents the control temperature.
*³“P” represents the productivity.
*⁴“MEP” represents the maximum electric power.

As shown in FIG. 1, when a user inputs an image forming job through the operating panel of the image forming apparatus E or a monitor screen of an external computer, the user sets the basis weight of the recording material to be used. As a result, the image forming apparatus E executes the heating of the recording material in the fixing device A on the basis of parameters stored in the controller 102, consisting of the control temperature, the productivity (the number of sheets per unit time of the recording material to be heated) and the maximum electric power.

Next, with respect to Comparative Embodiment in which no setting of the maximum electric power is made and Embodiment 1 in which the setting of the maximum electric power is made, the image formation was effected under conditions of the following experiments 1 to 3 to compare an occurrence state of the non-sheet-passing portion temperature rise.

### Experiment 1

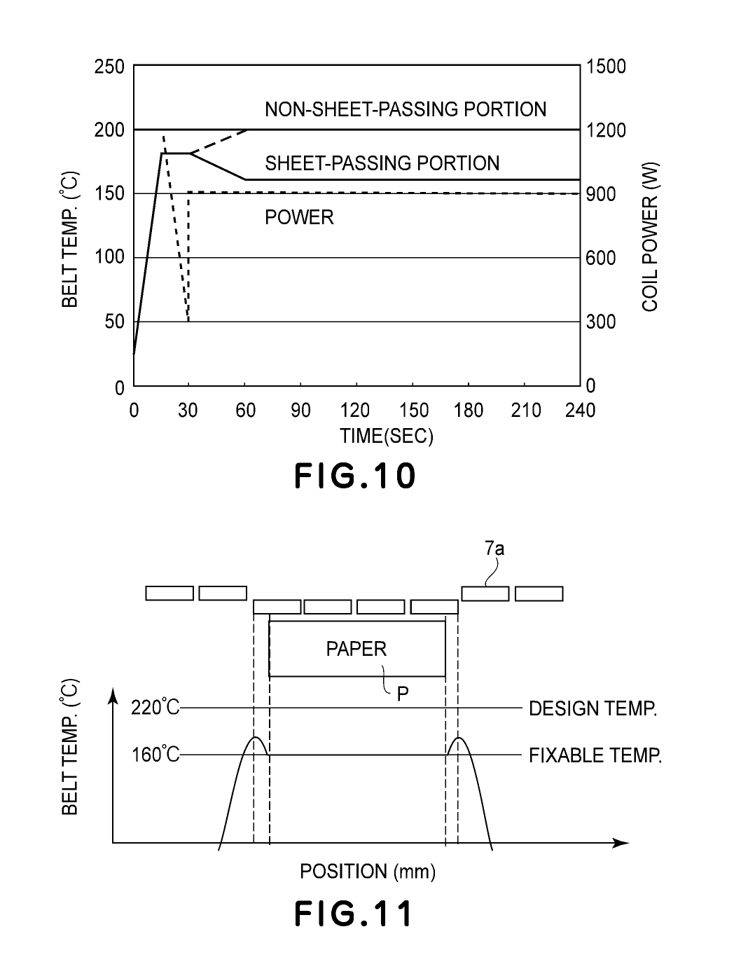

FIG. 10 is a graph showing a temperature change of the fixing belt at the sheet passing portion and the non-sheet-passing portion when plain paper is fed at setting of the plain paper. FIG. 11 is an illustration of a temperature distribution after continuous image formation of 500 sheets. Experiment 1 shows the case of “proper basis weight setting” such that the recording material of 80 g/m² in basis weight was actually fed in an image forming job for which the recording material of 80 g/m² in basis weight was set.

As shown in FIG. 10, after actuation, temperature control is effected so that the temperature of the fixing belt 1 at the sheet passing portion after rising to 180° C. and a lowering in electric power after temperature falling is kept at 160° C. during the sheet passing. In this state, with respect to the process speed of 300 mm/sec, an image interval of 240 mm is set and sheets of the A4-sized recording material are pressed through the fixing device at a rate of 75 sheets/min.

The temperature at the sheet passing portion is a measured temperature value of the fixing belt 1 at a longitudinal central recording material passing portion, and the temperature at the non-sheet-passing portion is a measured temperature value of the fixing belt 1 at a portion, where the temperature of the fixing belt 1 is increased, located outside the recording material passing portion of the fixing belt 1. With the feeding of the recording material, the sheet passing portion temperature indicated by a solid line was lowered to 160° C., and at the non-sheet-passing portion indicated by a broken line, the non-sheet-passing portion temperature rise occurred, but as indicated by a dotted line, the supplied electric power to the exciting coil 6 was 900 W and thus did not reach an upper limit of 1000 W.

As shown in FIG. 11, with respect to the rotation axis direction of the fixing belt 1, after the sheet passing of 500 sheets, the non-sheet-passing portion temperature rise to 200° C. occurred at the sheet passing portion. An experiment result of Experiment 1 is summarized in Table 2.

TABLE 2

| Exper- | BWS*¹ | ABW*² | MT*³ | P*⁴ | TR*⁵ | EP*⁶ |
|---|---|---|---|---|---|---|
| iment | (g/m²) | (g/m²) | (° C.) | (sheets/min) | (° C.) | (W) |
| EMB. 1 | 80 | 80 | 160 | 75 | 200 | 900 |
| COMP. | 80 | 80 | 160 | 75 | 200 | 900 |
| EMB. | | | | | | |

*¹“BWS” represents the basis weight setting.
*²“ABW” represents the actual basis weight.
*³“MT” represents the measured temperature value.
*⁴“P” represents the productivity.
*⁵“TR” represents the non-sheet-passing portion temperature rise.
*⁶“EP” represents the electric power during the sheet passing.

As shown in Table 2, in Experiment 1, with respect to both of Embodiment 1 and Comparative Embodiment, the sheet passing portion temperature is kept at the control temperature of 160° C. and the non-sheet-passing portion temperature is kept at 200° C. which is not more than the design temperature of 220° C. and therefore particularly no problem arises.

### Experiment 2

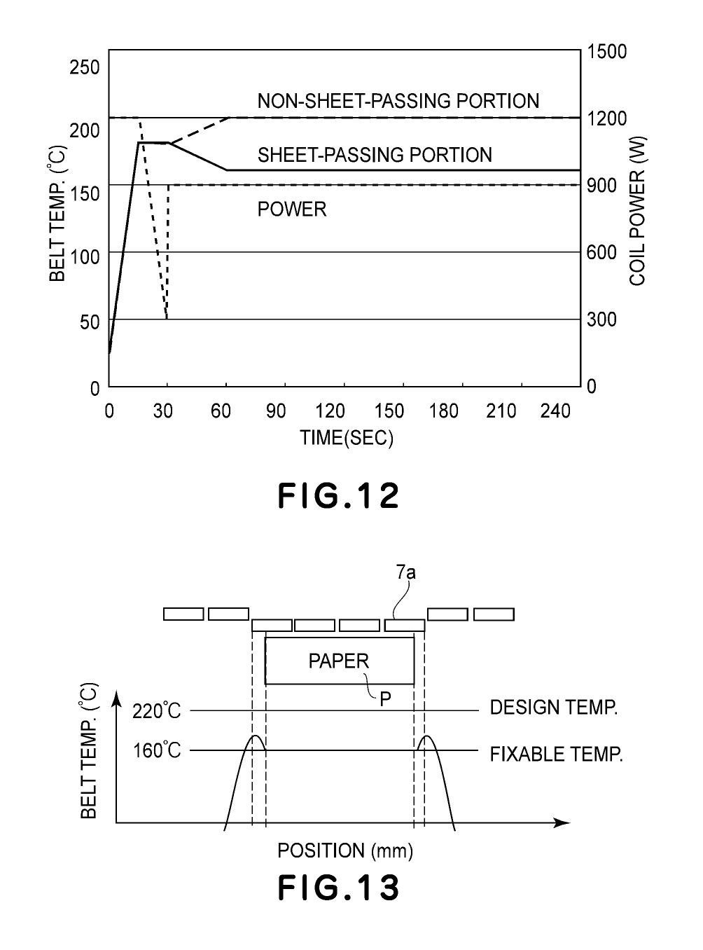

FIG. 12 is a graph showing a temperature change of the fixing belt at the sheet passing portion and the non-sheet-passing portion when thick paper is fed at setting of the thick paper. FIG. 13 is an illustration of a temperature distribution after continuous image formation of 500 sheets. Experiment 2 shows the case of “proper basis weight setting” such that the recording material of 160 g/m² in basis weight was actually fed in an image forming job for which the recording material of 160 g/m² in basis weight was set.

As shown in FIG. 12, in a state in which the temperature of the fixing belt 1 at the sheet passing portion is controlled at 160° C., with respect to the process speed of 300 mm/sec, an image interval of 300 mm is set and sheets of the A4-sized recording material are pressed through the fixing device at a rate of 60 sheets/min.

The sheet passing portion temperature indicated by a solid line was lowered to 160° C., and at the non-sheet-passing portion indicated by a broken line, the non-sheet-passing portion temperature rise occurred, but as indicated by a dotted line, due to the lowering in productivity, the supplied electric power to the exciting coil 6 was 900 W and thus did not reach an upper limit of 1000 W.

As shown in FIG. 13, with respect to the rotation axis direction of the fixing belt 1, after the sheet passing of 500 sheets, the non-sheet-passing portion temperature rise occurred at the sheet passing portion was 200° C. similarly as Experiment 1 since the supplied electric power was kept at 900 W. An experiment result of Experiment 2 is summarized in Table 3.

TABLE 3

| Exper- | BWS*¹ | ABW*² | MT*³ | P*⁴ | TR*⁵ | EP*⁶ |
|---|---|---|---|---|---|---|
| iment | (g/m²) | (g/m²) | (° C.) | (sheets/min) | (° C.) | (W) |
| EMB. 1 | 160 | 160 | 160 | 60 | 200 | 900 |
| COMP. | 160 | 160 | 160 | 60 | 200 | 900 |
| EMB. | | | | | | |

*¹“BWS” represents the basis weight setting.
*²“ABW” represents the actual basis weight.
*³“MT” represents the measured temperature value.
*⁴“P” represents the productivity.
*⁵“TR” represents the non-sheet-passing portion temperature rise.
*⁶“EP” represents the electric power during the sheet passing.

As shown in Table 3, in Experiment 2, with respect to both of Embodiment 1 and Comparative Embodiment, the sheet passing portion temperature is kept at the control temperature of 160° C. and the non-sheet-passing portion temperature is kept at 200° C. which is not more than the design temperature of 220° C. and therefore particularly no problem arises.

### Experiment 3

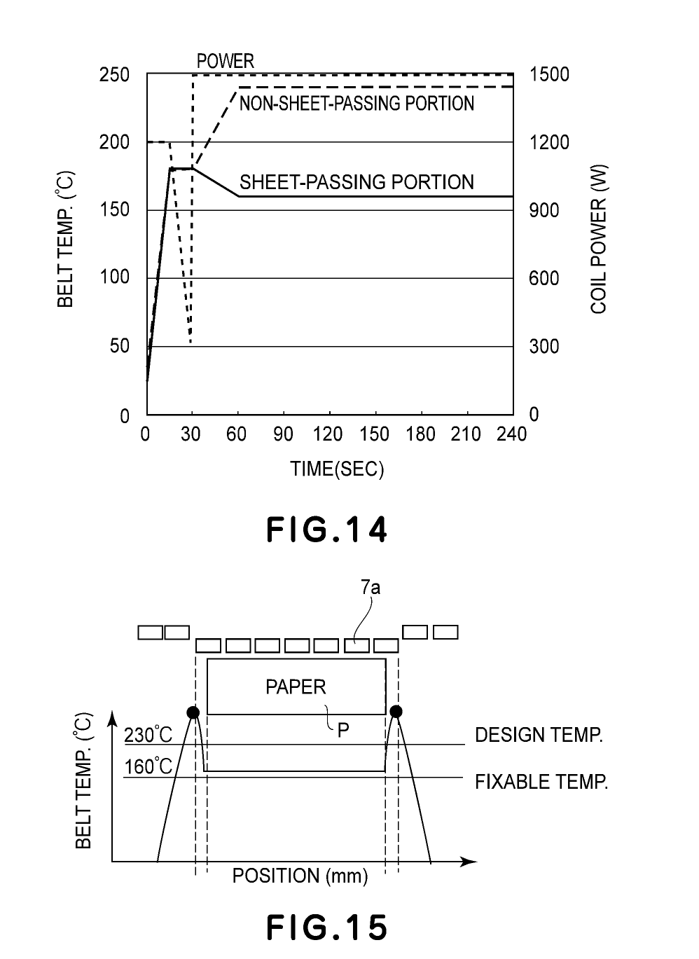

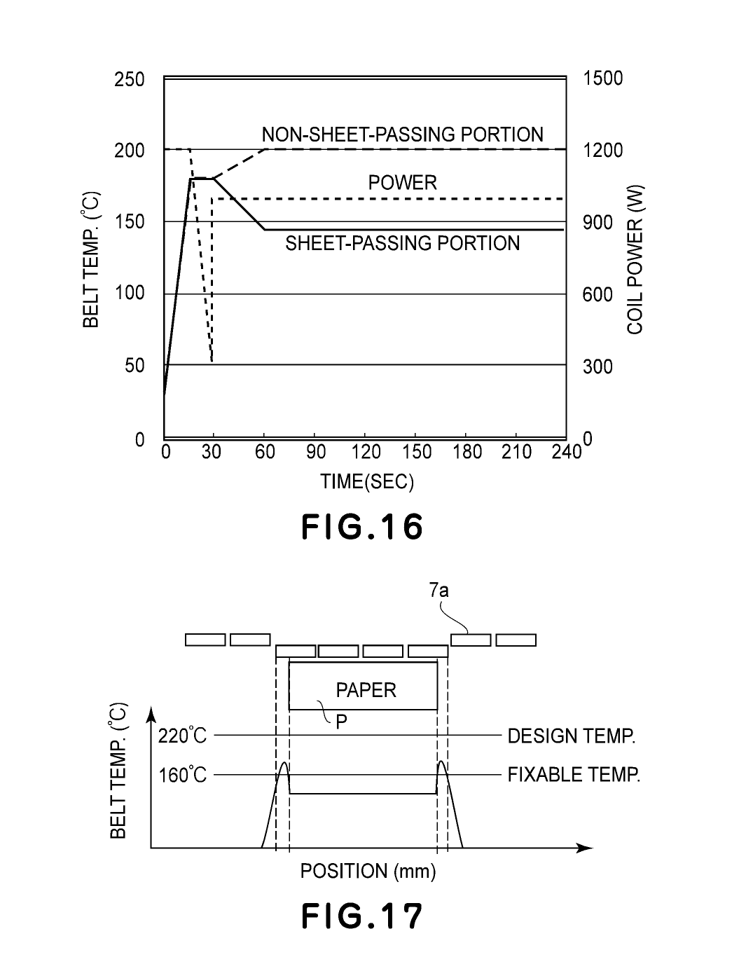

FIG. 14 is a graph showing a temperature change of the fixing belt in Comparative Embodiment at the sheet passing portion and the non-sheet-passing portion when the thick paper is fed at setting of the plain paper. FIG. 15 is an illustration of a temperature distribution after continuous image formation of 500 sheets. FIG. 16 is a graph showing a temperature change of the fixing belt at a sheet passing portion and a non-sheet-passing portion in Embodiment 1 when thick paper is fed at setting of the plain paper. FIG. 17 is an illustration of a temperature distribution after continuous image formation of 500 sheets. Experiment 3 shows the case of “erroneous basis weight setting” such that the recording material of 160 g/m² in basis weight was erroneously fed in an image forming job for which the recording material of 80 g/m² in basis weight was set.

As shown in FIG. 14, in a state in which the temperature of the fixing belt 1 at the sheet passing portion was controlled at 160° C., with respect to the process speed of 300 mm/sec, an image interval of 240 mm is set and sheets of the A4-sized recording material are pressed through the fixing device at a rate of 75 sheets/min.

In Comparative Embodiment, there is no limitation of the maximum electric power. For this reason, the electric power was supplied to the exciting coil 6 without limitation, so that the sheet passing portion temperature during the sheet passing was kept at 160° C. but the electric power of 1500 W was supplied in order to keep 160° C. As a result, as indicated by the broken line, at the non-sheet-passing portion, the non-sheet-passing portion temperature rise to 240° C. occurred.

As shown in FIG. 15, in Comparative Embodiment, the state of the supplied electric power of 1500 W was continued and therefore compared with Experiments 1 and 2, the fixing belt 1 was excessively induction-heated, so that the non-sheet-passing portion temperature rise occurred outside the sheet passing portion with respect to the rotation axis direction of the fixing belt 1 after the sheet passing of 500 sheets was 240° C.

On the other hand, as shown in FIG. 16, in Embodiment 1, the supplied electric power to the exciting coil 6 was limited to 1000 W and therefore the sheet passing portion temperature of the fixing belt 1 was not able to be kept at 160° C. and was lowered to 145° C. during the sheet passing. However, in Embodiment 1, the supply to the exciting coil 6 of the electric power of more than 1000 W was not effected, so that the non-sheet-passing portion temperature rise at the non-sheet-passing portion indicated by the broken line was 200° C. at the maximum.

As shown in FIG. 17, in Embodiment 1, the supplied electric power to the exciting coil 6 was limited to 1000 W and therefore the sheet passing portion temperature was below 160° C. after the sheet passing of 500 sheets but the non-sheet-passing portion temperature rise occurred outside the sheet passing portion with respect to the rotation axis direction of the fixing belt 1 was 200° C.

An experiment result of Experiment 3 is summarized in Table 4.

TABLE 4

| Exper- | BWS*¹ | ABW*² | MT*³ | P*⁴ | TR*⁵ | EP*⁶ |
|---|---|---|---|---|---|---|
| iment | (g/m²) | (g/m²) | (° C.) | (sheets/min) | (° C.) | (W) |
| EMB. 1 | 80 | 160 | 145 | 75 | 200 | 1000 |
| COMP. | 80 | 160 | 160 | 75 | 240 | 1500 |
| EMB. | | | | | | |

*¹“BWS” represents the basis weight setting.
*²“ABW” represents the actual basis weight.
*³“MT” represents the measured temperature value.
*⁴“P” represents the productivity.
*⁵“TR” represents the non-sheet-passing portion temperature rise.
*⁶“EP” represents the electric power during the sheet passing.

As shown in Table 4, in the control in Comparative Embodiment, the non-sheet-passing portion temperature rise is kept at 240° C. which exceeds the fixing belt design temperature of 220° C. and therefore there is a possibility that a durable lifetime of the fixing belt 1 is shortened. On the other hand, in the control in Embodiment 1, the non-sheet-passing portion temperature rise is kept at 200° C. which is less than the design temperature of 220° C. and therefore there is no possibility that the durable lifetime of the fixing belt 1 is shortened.

As described above, according to the control in Embodiment 1, even in the case where the setting of the basis weight of the recording material is erroneously made, by limiting the supplied electric power to the exciting coil 6, it is possible to prevent the fixing belt 1 from being exposed to the temperature which exceeds the design temperature.

Further, the setting of the maximum electric power supplied to the exciting coil 6 may be set depending on not only the basis weight of the recording material but also an ambient temperature where the image forming apparatus E is placed, so that more accurate control can be effected. The electric power value depending on the recording material type designated for the image formation is increased with a lower ambient temperature.

TABLE 5

| AT*¹ | BW*² | CT*³ | P*⁴ | MEP*⁵ |
|---|---|---|---|---|
| (° C.) | (g/m²) | (° C.) | (sheets/min) | (W) |
| ≦10° C. | 41-60 | 150 | 75 | 1000 |
| | 61-100 | 160 | 75 | 1100 |
| | 101-160 | 160 | 60 | 1100 |
| | 161-200 | 170 | 50 | 1100 |
| 11° C.-30° C. | 41-60 | 150 | 75 | 900 |
| | 61-100 | 160 | 75 | 1000 |
| | 101-160 | 160 | 60 | 1000 |
| | 161-200 | 170 | 50 | 1000 |
| 31° C.-45° C. | 41-60 | 150 | 75 | 800 |
| | 61-100 | 160 | 75 | 900 |
| | 101-160 | 160 | 60 | 900 |
| | 161-200 | 170 | 50 | 900 |

*¹“AT” represents the ambient temperature.
*²“BW” represents the basis weight.
*³“CT” represents the control temperature.
*⁴“P” represents the productivity.
*⁵“MEP” represents the maximum electric power.

According to the control in Embodiment 1, even in the case where the user erroneously sets the basis weight of the recording material, it is possible to prevent the durable lifetime of the fixing belt 1 from decreasing.

### Embodiment 2

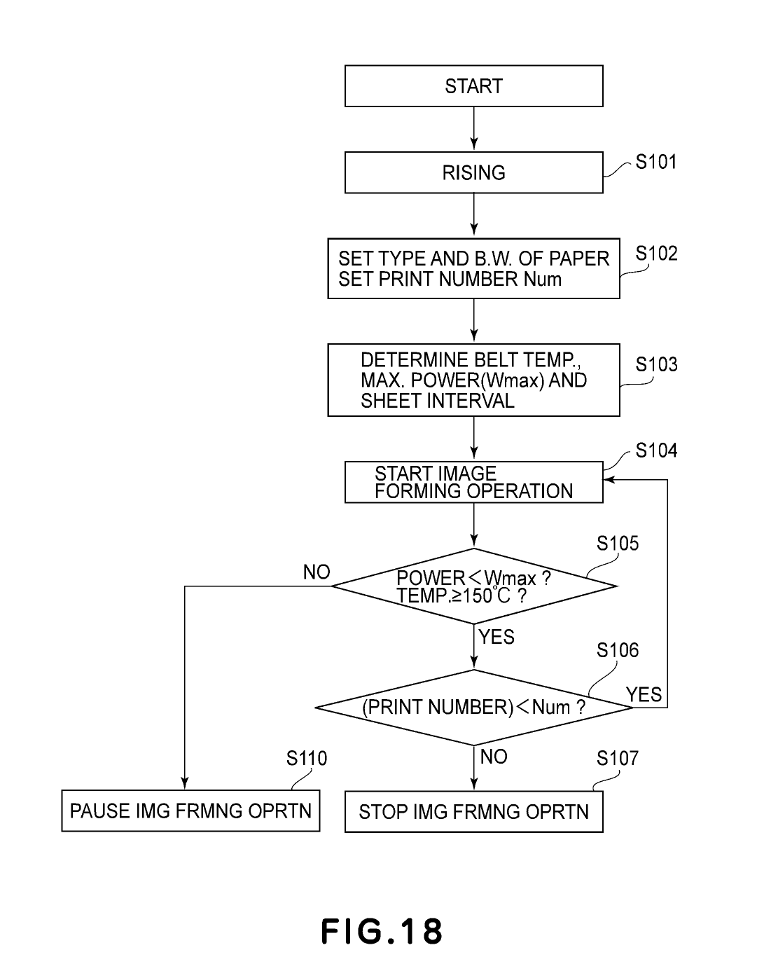

FIG. 18 is a flow chart of control in Embodiment 2. In this embodiment, in a state in which a supplied electric power for induction heating reaches a set value of maximum electric power, when a sheet passing portion temperature is below a design temperature, image formation is stopped.

As shown in FIG. 2, in Embodiment 1, even in the case where the user erroneously sets the basis weight of the recording material, the fixing belt 1 can be used within a range in which the fixing belt temperature does not exceed the design temperature. However, as described in Experiment 3, when the thick paper is passed through the fixing device at the plain paper setting, the sheet passing portion temperature of the fixing belt 1 is below a design temperature of 150° C. necessary to fix the toner image and therefore there is a possibility that fixing non-uniformity is generated on an outputted image.

Therefore, in Embodiment 2, the central thermistor TH1 which is an example of the detecting means detects the temperature of the fixing belt 1 in a range, with respect to the conveyance width direction, in which the fixing belt 1 is contacted to the recording material. The controller 102 stops feeding of the recording material by the cassette 31 in the case where the detection temperature by the central thermistor TH1 is below a predetermined value and cannot be maintained.

The controller 102 stops the image formation in the case where the measured temperature of the fixing belt 1 does not reach the design temperature even when the supplied electric power to the exciting coil 6 is increased up to the set value of the maximum electric power. As a result, the fixing belt 1 can be used at a temperature which does not exceed its heat-resistant limit temperature and it is also possible to prevent formation of an image for which the toner cannot be sufficiently fixed.

As shown in FIG. 18, when the image forming job is inputted, the rising of the fixing device A is executed (S101). The controller 102 obtains information of the designated recording material type and image formation (S102) and on the basis of the information, executes various settings as shown in Table 1 (S103).

The controller 102 starts the image formation (S104) and when the supplied electric power to the exciting coil 6 does not reach a maximum (YES of S105), the image formation is continued (YES of S106 and S104). When setting of the print number is ended (NO of S106), the controller 102 ends the image formation (S107).

In a state in which the supplied electric power to the exciting coil 6 reaches the maximum thereof, when the sheet passing portion temperature is below a lower limit fixable temperature (NO of S105), the image formation is interrupted (paused) (S110).

According to the control in Embodiment 2, even in the case where the user erroneously sets the basis weight of the recording material, it is possible to prevent the durable lifetime of the fixing belt 1 from decreasing, and it is also possible to prevent the fixing non-uniformity of an outputted image. It is possible to detect, with reliability, the case where a fixing performance cannot be satisfied, except for the case where the fixing performance can be sufficiently ensured only by temporary reaching of the electric power, supplied to the exciting coil 6, at the maximum. It is possible to prevent unnecessary image formation by using the user (operator) to check the recording material accommodated in the recording material cassette 31 and/or the setting of the recording material in the image forming job.

While the invention has been described with reference to the structures disclosed herein, it is not confined to the details set forth and this application is intended to cover such modifications or changes as may come within the purpose of the improvements or the scope of the following claims.

This application claims priority from Japanese Patent Application No. 170802/2011 filed Aug. 4, 2011, which is hereby incorporated by reference.

What is claimed is:

1. An image heating apparatus comprising:
a coil for generating magnetic flux;
a rotatable heat generating member for generating heat by the magnetic flux from said coil;
a nip forming member for forming a nip, together with said heating member, in which an image on a recording material is to be heated;
a power source for supplying electric power to said coil;
a sensor for detecting a temperature of said heat generating member;
a controller for controlling, on the basis of a detection result of said sensor, said power source so that the temperature of said heat generating member is a set image heating temperature;
an executing portion for executing an operation in a first mode in which said heat generating member is rotated at a first speed when the recording material with a first thickness is conveyed into the nip and for executing an operation in a second mode in which said heat generating member is rotated at a second speed lower than the first speed when the recording material with a second thickness larger than the first thickness is conveyed into the nip; and
a prohibiting portion for prohibiting the electric power, supplied from said power source to said coil by said controller, from exceeding a limiter value,
wherein the limiter value when the operation in the second mode is executed is set so as to be higher than that when the operation in the first mode is executed.

2. An apparatus according to claim 1, further comprising a feeding portion for feeding the recording material toward the nip,
wherein said feeding portion stops, when a value of the electric power supplied from said power source to said coil reaches the limiter value, an operation for feeding the recording material toward the nip.

3. An apparatus according to claim 1, wherein the limiter value when an ambient temperature is a first ambient temperature is set so as to be larger than that when the ambient temperature is a second ambient temperature lower than the first ambient temperature.

4. An apparatus according to claim 1, wherein said controller changes a frequency of an AC current supplied from said power source to said coil.

5. An apparatus according to claim 1, wherein said controller lowers a frequency of an AC current supplied from said power source to said coil when the temperature detected by said sensor is lower than the image heating temperature.

6. An apparatus according to claim 1, further comprising an adjusting means for adjusting the magnetic flux from said coil toward said heat generating member.

7. An apparatus according to claim 6, wherein said adjusting means adjusts, when a predetermined recording material with a length smaller than that of a passable maximum-sized recording material with respect to a rotation axis direction of said heat generating member is conveyed, the magnetic flux so that a magnetic flux density in a region located outside a predetermined region with respect to the rotation axis direction is smaller than that in the predetermined region.

8. An apparatus according to claim 7, wherein said adjusting means includes a plurality of magnetic cones provided and arranged in the rotation axis direction of said heat generating member and includes a core moving mechanism for moving at least a part of the magnetic cones so that a gap between said heat generating member and the magnetic cones is changed.

9. An apparatus according to claim 8, wherein the core moving mechanism is, when the recording material with the length smaller than that of the passable maximum-sized recording material with respect to the rotation axis direction is conveyed, controlled so that the magnetic cones located in the region outside the predetermined region are moved away from said heat generating member more than the magnetic cones located in the predetermined region.

10. An apparatus according to claim 1, further comprising an inputting portion into which information on a basis weight of the recording material is to be inputted.
